(19) United States
(12) Patent Application Publication
(10) Pub. No.: US 2025/0018264 A1
(43) Pub. Date: Jan. 16, 2025

(54) PICKLEBALL PADDLE WITH A CENTRALIZED CORE

(71) Applicant: Gearbox, Inc., San Diego, CA (US)

(72) Inventor: Rafael Garcia Filippini, San Diego, CA (US)

(73) Assignee: Gearbox, Inc., San Diego, CA (US)

(21) Appl. No.: 18/581,545

(22) Filed: Feb. 20, 2024

(30) Foreign Application Priority Data
Jul. 14, 2023 (TW) 112126434

(51) Int. Cl. A63B 59/42; A63B 60/08; B32B 3/12; B32B 3/18; B32B 5/02; B32B 27/12; B32B 27/30; B32B 27/32

(52) U.S. Cl. CPC A63B 59/42; A63B 60/08; B32B 3/12; B32B 3/18; B32B 5/02; B32B 27/12; B32B 27/306; B32B 27/32; A63B 2209/00; B32B 2262/101; B32B 2262/106

(57) ABSTRACT

A pickleball paddle with a centralized core, comprises a plate body and a grip body, the plate body has a core, a frame and two surface layers, the frame is disposed on a periphery of the core, the plate body defines a first ball-striking response part and a second ball-striking response part in corresponding to the core, the first ball-striking response part is located at a central part of the core, the first ball-striking response part and the second ball-striking response part respectively have a first response parameter and a second response parameter different from each other, the two surface layers are spaced apart from each other and respectively assembled on the core and the frame, the two surface layers correspond to the first ball-striking response part and the second ball-striking response part.

### FIELD OF THE INVENTION

The invention is related to a pickleball paddle with a centralized core.

### BACKGROUND OF THE INVENTION

Pickleball is a sport played with a paddle and is becoming very popular rapidly. It has always been the goal of manufacturers to pursue manufacturing a paddle capable of improving the performance of the user and strengthening the confidence of the user.

Please refer to FIG. 1 for a schematic diagram of U.S. Pat. No. 10,377,093B2, which discloses the pickleball paddle provided with the core C made of carbon fiber material. However, due to application of a large area of hard carbon fiber material, the core C has high stiffness, small deflection, low flexion, and high coefficient of restitution (COR). As a result, it is difficult for the core C to deform, which is not conducive to controlling a duration that a pickleball stays on the pickleball paddle, nor is it conducive to controlling a rotational force of the pickleball paddle on the pickleball.

### SUMMARY OF THE INVENTION

An object of the invention is to provide a pickleball paddle with a centralized core to solve the problems mentioned above in the prior art.

According to one embodiment of the invention, a pickleball paddle with a centralized core provided comprises a plate body having a core, a frame and two surface layers, the frame is disposed on a periphery of the core, the plate body defines a first ball-striking response part and a second ball-striking response part adjacent to each other in corresponding to the core, the first ball-striking response part is located at a central part of the core, the first ball-striking response part and the second ball-striking response part respectively have a first response parameter and a second response parameter different from each other, the two surface layers are spaced apart from each other and respectively assembled on the core and the frame, the two surface layers correspond to the first ball-striking response part and the second ball-striking response part.

Thereby, deformation can be easily achieved through combination of the first ball-striking response part and the second ball-striking response part with the different response parameters, which is conducive to controlling a duration that a pickleball stays on the plate body, and is also conducive to controlling a rotational force of the plate body on the pickleball.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 is a schematic plan view of a conventional pickleball paddle;

FIG. 2 is a plan assembled view of a first embodiment of a pickleball paddle with a centralized core of the invention;

FIG. 3 is an assembled sectional view of the pickleball paddle with the centralized core of the invention;

FIG. 4 is a partial exploded view of the pickleball paddle with the centralized core of the invention;

FIG. 5 is another partial exploded view of the pickleball paddle with the centralized core of the invention;

FIG. 6 is a plan assembled view of a second embodiment of the pickleball paddle with the centralized core of the invention;

FIG. 7 is a partial exploded view of the pickleball paddle with the centralized core of the invention;

FIG. 8 is another partial exploded view of the pickleball paddle with the centralized core of the invention; and

FIG. 9 is a schematic plan view of the pickleball paddle with the centralized core of the invention provided with a filler.

### DETAILED DESCRIPTION OF THE PREFERRED EMBODIMENTS

The invention provides a pickleball paddle with a centralized core. The invention takes a pickleball paddle as an example, but the pickleball paddle is also applicable to paddles of different sizes, such as table tennis paddle or beach paddle.

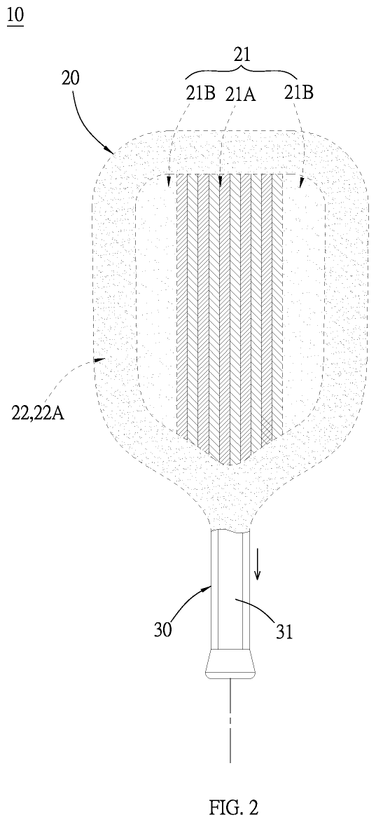

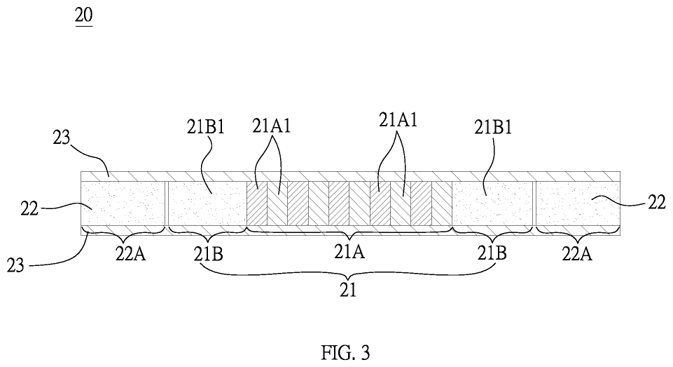

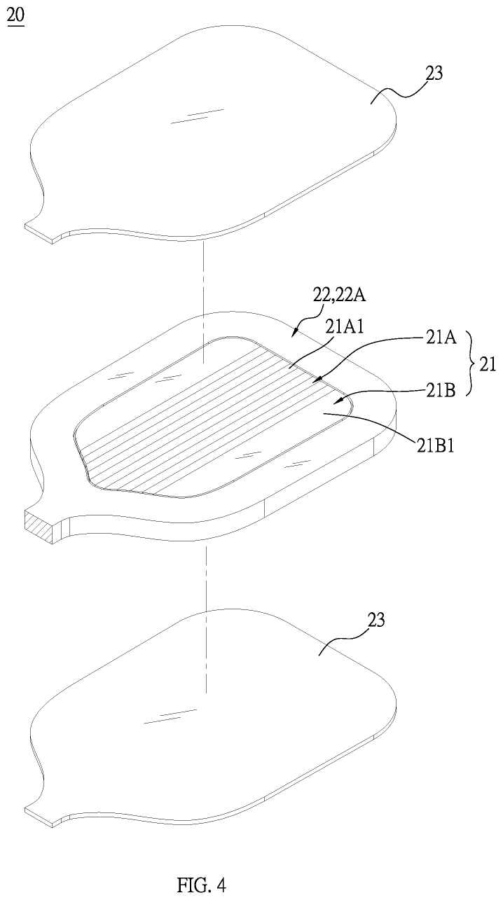

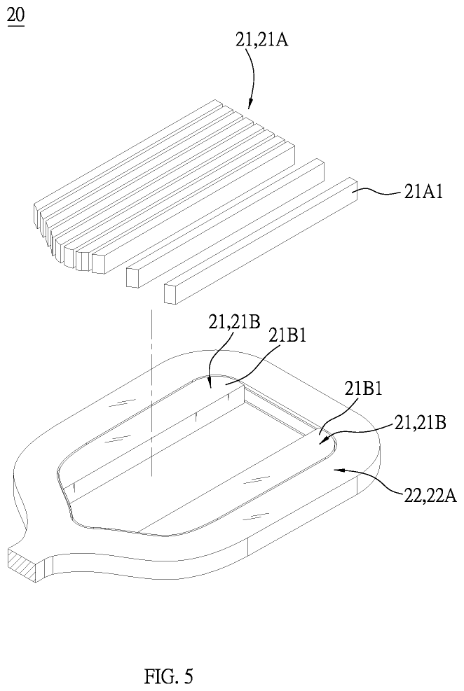

Please refer to FIG. 2 to FIG. 5 at the same time, a pickleball paddle 10 of a first embodiment comprises a plate body 20 and a grip body 30, the plate body 20 comprises a core 21 and a frame 22, and the frame 22 is disposed on a periphery of the core 21. The plate body 20 defines a first ball-striking response part 21A and a second ball-striking response part 21B adjacent to each other in corresponding to the core 21, and the plate body 20 defines a third ball-striking response part 22A in corresponding to the frame 22.

Wherein the first ball-striking response part 21A is located at a central part of the core 21, that is, the so-called “sweet spot” being the best ball-striking response part. The central part is referenced to an axis of FIG. 2 and its vicinity.

The second ball-striking response part 21B is located at a position away from the central part of the core 21, or the second ball-striking response part 21B is partially located at the central part of the core 21, or the second ball-striking response part 21B is partially located at a position away from the central part of the core 21. The second ball-striking response part 21B is used to narrow the first ball-striking response part 21A so that the first ball-striking response part 21A is concentrated at the central part of the core 21. Thereby, the core 21 is capable of deforming easily through combination of the first ball-striking response part 21A and the second ball-striking response part 21B, deformation is achieved by reducing a stiffness, increasing a deflection, enhancing a flexion, and reducing a coefficient of restitution (COR).

A first embodiment of the second ball-striking response part 21B is located on two sides of the first ball-striking response part 21A, or a second embodiment of the second ball-striking response part 21B is located on a peripheral side of the first ball-striking response part 21A, but it is not limited to the embodiments disclosed above.

The first ball-striking response part 21A has a first response parameter, the second ball-striking response part 21B has a second response parameter, and the third ball-striking response part 22A has a third response parameter. The first ball-striking response part 21A, the second ball-striking response part 21B and the third ball-striking response part 22A can be made of different materials. The second ball-striking response part 21B and the third ball-striking response part 22A can be made of a same material. Each of the response parameters can be stiffness, but is not limited to stiffness (for example, one or a combination of deflection, flexion and coefficient of restitution related to stiffness).

Taking different stiffnesses adopted for the core 21 as an example, a stiffness of the first ball-striking response part 21A is greater than a stiffness of the second ball-striking response part 21B and a stiffness of the third ball-striking response part 22A as an embodiment. When a pickleball is hit by the first ball-striking response part 21A, the pickleball stays on the pickleball paddle 10 for a short time, which is not conducive to controlling a rotational force of the plate body 20 on the pickleball. On the contrary, when the pickleball is hit by the second ball-striking response part 21B and the third ball-striking response part 22A, the pickleball stays on the pickleball paddle 10 for a longer time, which is conducive to controlling a rotation force of the plate body 20 on the pickleball. Thereby, a user can choose to use the first ball-striking response part 21A, or the second ball-striking response part 21B, or the third ball-striking response part 22A according to different ball-striking strategies.

The first ball-striking response part 21A is further provided with a plurality of first components 21A1 that are polygonal columnar, cylindrical, semi-cylindrical, curved columnar, or deformation of the aforementioned columnar shapes. The first component 21A1 has the first response parameter. The first components 21A1 are arranged with one another. Any one of the first components 21A1 extends between corresponding frame edges of the frame 22. Wherein the first components 21A1 are arranged longitudinally with one another as one embodiment, or the first components 21A1 are arranged transversely with one another as another embodiment, or the first components 21A1 are arranged obliquely with one another as yet another embodiment, but the first components 21A1 are not limited to either the longitudinal arrangement, the transverse arrangement or the oblique arrangement disclosed above or a combination thereof.

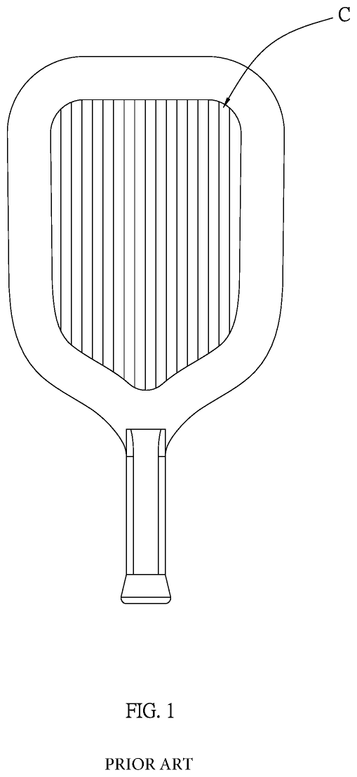

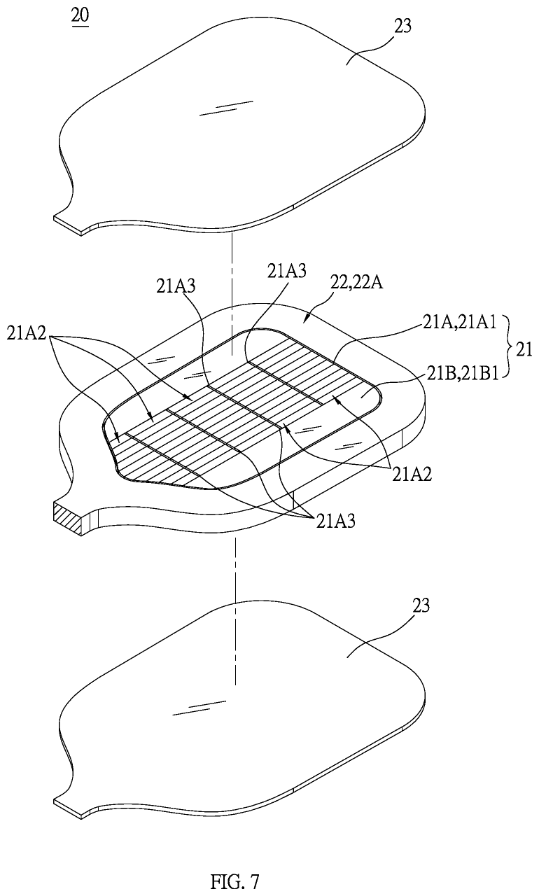

Each of the first components 21A1 is made of either honeycomb structure or rib structure, but the first components 21A1 are not limited thereto. For the honeycomb structure, please refer to FIG. 1 of US Patent Publication No. US20180104555A1, for the rib structure, please refer to FIG. 7 of US Patent Publication No. U.S. Pat. No. 10,377,093B2, the aforementioned patents are for reference only, and are not intended to limit the first components 21A1. In addition, each of the first components 21A1 is made of either carbon fiber material, hard plastic material or hard foam material, but the first components 21A1 are not limited thereto.

The second ball-striking response part 21B is further provided with polygonal second components 21B1, the second components 21B1 have the second response parameters, and the second component 21B1 is made of either polyethylene (PE) or ethylene-vinyl acetate (EVA) copolymer, but is not limited thereto. In addition, the first component 21A1 of the first ball-striking response part 21A and the second component 21B1 of the second ball-striking response part 21B are interchangeable, that is, the first component 21A1 or the second component 21B1 can be used for the first ball-striking response part 21A or the second ball-striking response part 21B to meet the user's demand.

The frame 22 has a third response parameter, and the frame 22 is made of either polyethylene (PE) or ethylene-vinyl acetate (EVA) copolymer, but is not limited thereto.

Therefore, the first response parameter of the first ball-striking response part 21A being stiffness and the second response parameter of the second ball-striking response part 21B being stiffness, respectively depend on the first component 21A1 and the second component 21B1 made of different materials to have different stiffnesses to correspond to the first response parameter and the second response parameter. The second response parameter of the second ball-striking response part 21B being stiffness and the third response parameter of the third ball-striking response part 22A being stiffness, respectively depend on the second component 21B1 and the frame 22 made of a same material to have a same stiffness to correspond to the second response parameter and the third response parameter.

The invention takes the first response parameter of the first component 21A1 of the first ball-striking response part 21A being stiffness greater than the second response parameter of the second component 21B1 of the second ball-striking response part 21B being stiffness as the first embodiment, or the first response parameter of the first component 21A1 of the first ball-striking response part 21A being stiffness smaller than the second response parameter of the second component 21B1 of the second ball-striking response part 21B being stiffness as the second embodiment, but the invention is not limited to the above-disclosed embodiments.

An area of the first ball-striking response part 21A and an area of the second ball-striking response part 21B of the invention depend on the user's demand. For example, if a demand lies in the pickleball paddle 10 with high stiffness, the first ball-striking response part 21A with large area and high stiffness can be used as the first embodiment. On the contrary, if a demand lies in the pickleball paddle 10 with low stiffness, the second ball-striking response part 21B with large area and low stiffness can be used as the second embodiment, but the invention is not limited to the above-disclosed embodiments.

The plate body 20 further comprises two surface layers 23 spaced apart from each other. Each of the surface layers 23 is respectively assembled on the core 21 and the frame 22, each of the surface layers 23 is respectively further assembled on the first component 21A1 of the first ball-striking response part 21A, the second component 21B1 of the second ball-striking response part 21B, and the frame 22 of the third ball-striking response part 22A, so that each of the surface layers 23 corresponds to the first ball-striking response part 21A, the second ball-striking response part 21B and the third ball-striking response part 22A. The two surface layers 23 are made of either a carbon fiber or a glass fiber, but the invention is not limited thereto.

The first ball-striking response part 21A, the second ball-striking response part 21B and the third ball-striking response part 22A are adopted to create unique functions of the pickleball paddle 10 based on the user's unique ball-striking attributes. Thereby, the invention alternately uses the different ball-striking response parts for different ball-striking strategies in order to control a duration that a pickleball stays on the plate body 20, and also to control a rotational force of the plate body 20 on the pickleball.

The grip body 30 is formed from a bottom side of the frame 22 of the plate body 20, and can be formed by extending longitudinally or by connecting longitudinally. The longitudinal direction refers to a direction of an arrow in FIG. 2. The grip body 30 and the plate body 20 can be made of a same material or can be made of different materials. Width and thickness of the grip body 30 are different from those of the plate body 20, variations in width and thickness are provided for the user to grip comfortably. The grip body 30 is further assembling with a handle 31, a further embodiment of the aforementioned assembling is sleeving, but is not limited to sleeving. The handle 31 is made of a synthetic rubber, but is not limited thereto. The handle 31 enables the user to control the plate body 20 more stably.

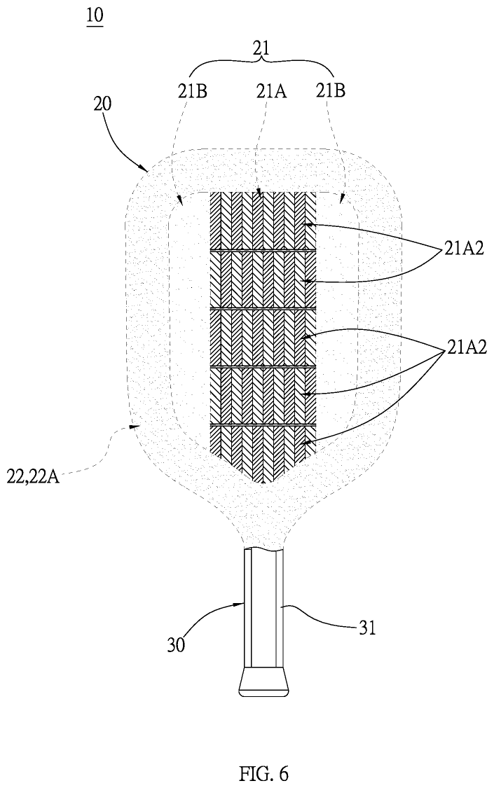

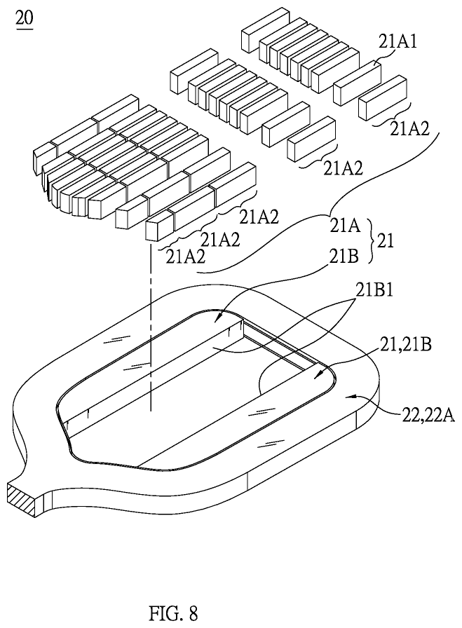

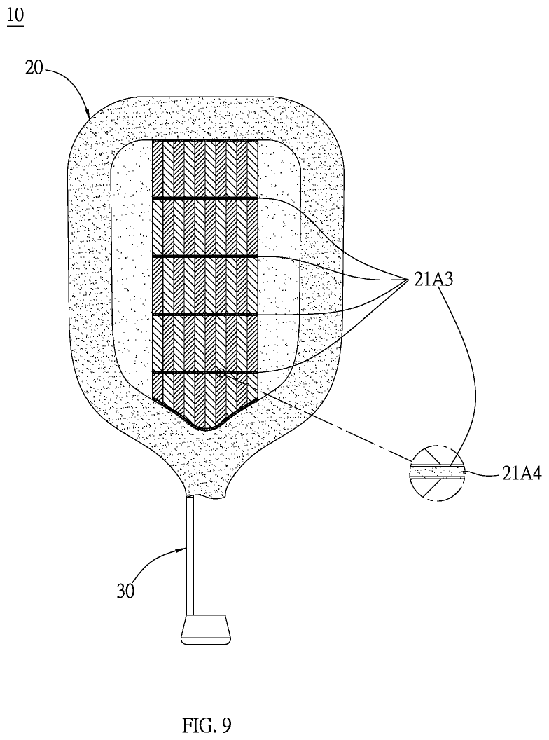

Please refer to FIGS. 6 to 9 at the same time. Differences between the second embodiment and the first embodiment lie in the first ball-striking response part 21A. The first ball-striking response part 21A of the second embodiment further defines at least two response blocks 21A2 adjacent to each other, a segment gap 21A3 is further provided between any two of the response blocks 21A2, and a size of the segment gap 21A3 depends on density or sparseness of arrangement of any two of the response blocks 21A2. Each of the response blocks 21A2 is provided with the first components 21A1, the segment gap 21A3 is further provided with a filler 21A4, the filler 21A4 has a coefficient of elasticity, the coefficient of elasticity depends on the user's demands, and differences in the coefficient of elasticity will cause changes in ball-striking sound. The filler 21A4 is further a rubber band with the coefficient of elasticity.

Descriptions of “first”, “second” and “third” mentioned in the invention are used for distinction and do not represent a sequence.

In summary:

the core 21 of the invention is capable of deforming easily through combination of the first ball-striking response part 21A and the second ball-striking response part 21B, deformation is achieved by reducing a stiffness, increasing a deflection, enhancing a flexion, and reducing a coefficient of restitution (COR), in order to control a duration that a pickleball stays on the plate body 20, and also to control a rotational force of the plate body 20 on the pickleball.

The invention provides the first ball-striking response part 21A, the second ball-striking response part 21B and the third ball-striking response part 22A different from one another and provided with matching of different materials, in order to avoid buying multiple paddles and reduce burden on paddle costs.

The invention is capable of alternately using the first ball-striking response part 21A, the second ball-striking response part 21B and the third ball-striking response part 22A different from one another according to different ball-striking strategies to flexibly control a surface of the pickleball paddle 10, meet the user's demands, and seize an opportunity to win.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A pickleball paddle with a centralized core, comprising a plate body, the plate body comprising:
a core, the plate body defining a first ball-striking response part and a second ball-striking response part adjacent to each other in corresponding to the core, the first ball-striking response part being located at a central part of the core, the first ball-striking response part and the second ball-striking response part respectively having a first response parameter and a second response parameter different from each other;
a frame, the frame being disposed on a periphery of the core; and
two surface layers, the two surface layers being spaced apart from each other and respectively assembled on the core and the frame, the two surface layers corresponding to the first ball-striking response part and the second ball-striking response part.

2. The pickleball paddle with the centralized core as claimed in claim 1, wherein the plate body defines a third ball-striking response part in corresponding to the frame, the two surface layers correspond to the third ball-striking response part, the first ball-striking response part with the first response parameter and the third ball-striking response part with a third response parameter are made of different materials, the second ball-striking response part with the second response parameter and the third ball-striking response part with the third response parameter are made of a same material, the first response parameter, the second response parameter and the third response parameter are stiffness.

3. The pickleball paddle with the centralized core as claimed in claim 1, wherein the second ball-striking response part is located at a position away from the central part of the core, and the second ball-striking response part is further located on two sides of the first ball-striking response part.

4. The pickleball paddle with the centralized core as claimed in claim 1, wherein the second ball-striking response part is partially located at the central part of the core, the second ball-striking response part is partially located at a position away from the central part of the core, and the second ball-striking response part is further located on a peripheral side of the first ball-striking response part.

5. The pickleball paddle with the centralized core as claimed in claim 1, wherein the first ball-striking response part with the first response parameter and the second ball-striking response part with the second response parameter are made of different materials, the first response parameter and the second response parameter are stiffness.

6. The pickleball paddle with the centralized core as claimed in claim 1, wherein the first ball-striking response part is further provided with a plurality of first components, the first components have the first response parameters, the first components are arranged with one another, the first components extend between corresponding frame edges of the frame, the first ball-striking response part further comprises at least two response blocks, a segment gap is further formed between any two of the at least two response blocks, the at least two response blocks are further provided with the first components, the segment gap is further provided with a filler, the filler has a coefficient of elasticity, and the filler is further a rubber band with the coefficient of elasticity.

7. The pickleball paddle with the centralized core as claimed in claim 6, wherein the first components are either arranged longitudinally with one another, or arranged transversely with one another, or arranged obliquely with one another, or arranged with one another in a combination of the above arrangements, the first components are made of either honeycomb structure or rib structure, the first components are made of either carbon fiber material, hard plastic material or hard foam material.

8. The pickleball paddle with the centralized core as claimed in claim 1, wherein the second ball-striking response part is further provided with second components, the second components have the second response parameters, and the second components are made of either polyethylene (PE) or ethylene-vinyl acetate (EVA) copolymer.

9. The pickleball paddle with the centralized core as claimed in claim 1, wherein the frame is made of either polyethylene (PE) or ethylene-vinyl acetate (EVA) copolymer, and the two surface layers are made of either a carbon fiber or a glass fiber.

10. The pickleball paddle with the centralized core as claimed in claim 1, wherein further comprising a grip body, the grip body being formed by extending longitudinally or by connecting longitudinally from a bottom side of the frame of the plate body, the grip body being further assembled with a handle, and the handle being made of a synthetic rubber.
